(19) United States
(12) Patent Application Publication
(10) Pub. No.: US 2002/0026498 A1
(43) Pub. Date: Feb. 28, 2002

(54) System and method for providing a community service to users of the internet

(76) Inventor: Ki Sung Kim, Seoul (KR)

Correspondence Address: Timothy J. Keefer, Wildman, Harrold, Allen & Dixon, 225 West Wacker Drive, Chicago, IL, 60616, US

(21) Appl. No.: 09/945,014

(22) Filed: Aug. 31, 2001

(30) Foreign Application Priority Data
Aug. 31, 2000 (KR) 2000-51097

(51) Int. Cl. G06F 15/173; G06F 15/16

(52) U.S. Cl. 709/218; 709/225; 709/230

(57) ABSTRACT

The present invention provides a system and method for obtaining wanted information that a complicated registration procedure may be omissible and a temporary community may be created on the basis of IP addresses of the users by the unit of web page, thereby allowing users to exchange information for more effective search. A server computer according to the present invention, interconnected with a plurality of user computers via the Internet, includes: a database for storing user information of the plurality of users respectively; a memory for temporarily storing a web page requested by the plurality of users respectively; a user community server for updating the database upon receipt of the web page from the plurality of users, and extracting a list of current users of the requested web page from the user information stored in the database; and a web server for receiving the extracted user list, and providing the list to the corresponding users by adding at a predefined position on a corresponding web page respectively, the web page stored temporarily.

### FIELD OF THE INVENTION

The present invention relates to a computer system operated under an Internet environment, and more particularly to, a system and method for providing a community service to Internet users viewing a same web page of a website, thereby allowing them to exchange information with each other.

### BACKGROUND OF THE INVENTION

Generally, an Internet user utilizes a search engine or a direct link for seeking his/her wanted information provided by websites on the Internet. The user has to set a search condition in order to find one or more websites that possibly contain wanted information and has to visit the websites that are found to see their contents.

Currently there are some websites that provide community services that help users to exchange information between them; however, those services have been provided only to members registered with the websites. FIG. 1 illustrates a system for carrying out a conventional method providing a member-only community service. The, conventional system typically includes a server computer 1 and user computers/clients 3, 4 and 5, interconnected through the Internet 2.

The user computers 3, 4 and 5 are equipped with display devices and input devices, which are commonly used by users for the purpose of connecting to a web server 40. A server computer 1 includes a main controller 1, a network module 20, a network interface 30, the web server 40, a member-only community server 50, and a member DB 60.

The main controller 10 controls the interface with the network module 10.

The network module 20 processes packets transmitted over the network.

The network interface 30 conducts converting analogue signals of the network and digital signals in the system.

The web server 40 provides a user with a web page created in HTML (Hyper Text Markup Language), for example.

When a user registers for a member-only community service, the member-only community server 50 receives user information such as member ID, contact numbers, and stores them in the member DB 60. When a user requests the member-only community service, the web server 40 requests user authentication from the member-only community server 50 before it provides the user with the member-only community service. The member-only community server 50 receives user information such as the member ID needed for verifying membership status through the web server 40, and compares the received information to that of the user DB 60. If the user is verified as a registered member, then the member-only community server 50 transmits a corresponding web page.

The conventional community services have allowed users to exchange information with other members registered with the community services, only after joining the community service by inputting predetermined user information. Accordingly, it was compulsory to register with a particular community service although a user merely wishes to join the community service on a trial basis. Therefore, those reluctant to register with the community service could not participate in the community.

Furthermore, if there is no community of users having similar interests, it was very difficult for a user to have interaction with other users. Moreover, users had to spend a considerable amount of time reading and checking the contents of websites for seeking wanted information.

### SUMMARY OF THE INVENTION

Therefore, it is the main objective of the present invention to provide a system and method for obtaining wanted information that a complicated registration procedure may be omissible and a temporary community may be created on the basis of IP addresses of the users by the unit of web page, thereby allowing users to exchange information to each other for more effective search.

It is another objective of the present invention to provide a system and method that enables interaction between users having similar interests and accessing in a particular web page by providing a list of current users thereof.

According to one embodiment of the present invention, there is provided a server computer, interconnected with a plurality of user computers via the Internet, including: a database for storing user information of the plurality of users respectively; a storing means for temporarily storing a web page requested by the plurality of users respectively; a first processing means for updating the database upon receipt of the web page from the plurality of users respectively, and extracting a list of current users of the requested web page from the user information stored in the database; and a second processing means for receiving the extracted user list, and providing the list to the corresponding users by adding at a predefined position on a corresponding web page respectively, the web page stored temporarily.

According to another embodiment of the present invention, there is provided a method for providing a list of current users of a particular web page in a server computer, the server computer interconnected with a plurality of user computers via the Internet, including the steps of: a) temporarily storing a web page requested by the plurality of users upon receipt of requests from the users; b) storing user information of the plurality of users respectively; c) extracting the list of current users of the requested web page from the information stored at the step (c); and d) providing the list to corresponding users by adding at a predefined position on the corresponding web page respectively, the web page stored temporarily.

### BRIEF DESCRIPTION OF THE DRAWINGS

These and other objects of the invention will be seen by reference to the description, taken in connection with the accompanying drawings, in which:

FIG. 1 illustrates a system for carrying out a conventional method providing a member-only community service.

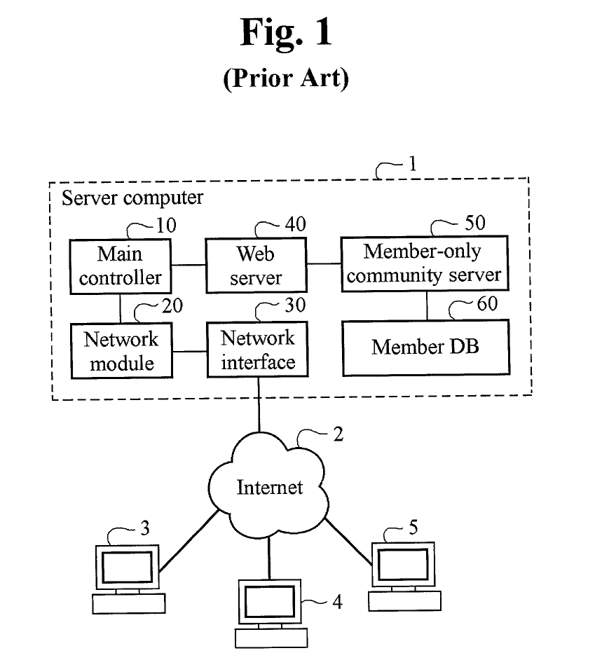

FIG. 2 illustrates a system for carrying out a method providing users with a community service according to the present invention.

FIG. 3 denotes a data format stored at a user DB of the present invention.

FIG. 4 shows a flow of a process for providing the community service according to the present invention.

FIG. 5 depicts an exemplary screen displaying a current user list.

FIG. 6 depicts an exemplary screen displaying receipt of an invitation.

### DETAILED DESCRIPTION OF THE PREFERRED EMBODIMENT

Users visiting a particular web page, in the present invention, may create a temporary community and exchange information with other users visiting the same web page.

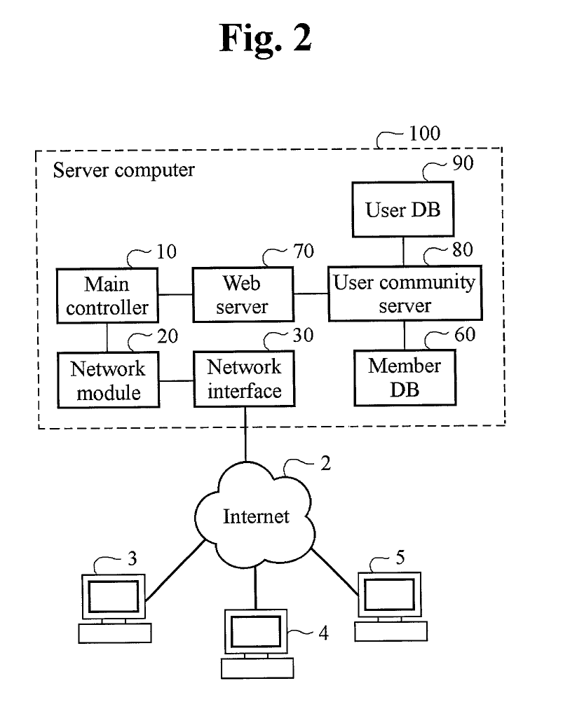

FIG. 2 illustrates a system according to the present invention. The system includes a server computer 100 and user computers/clients 3, 4 and 5, interconnected via the Internet 2. The user computers 3, 4 and 5 and the server computer 100 have their own IP (Internet Protocol) addresses.

The server computer 100 stores user information such as the IP address per web page for a predetermined time. That is, it manages user information by checking users visiting a web page, periodically. Also, it provides user information of a particular web page with current users on the web page. In other words, it updates a list of users who are viewing now or viewed a particular web page to a user requesting access to the web page on his/her computer screen. The user may invite some or all the users in the list to a chat room, or send a message. Users receiving the invitation or the message receives a message window including the invitation or message from the server computer 100 when the user moves the web page. That is, the user requests data from the server computer 100 and, responding to this, the server computer 100 transmits the data to the user in a message window on the user computer.

The user list can be a list of certain IDs determined by a predetermined ID determining rule in accordance with IP addresses of the users, or a list of member IDs of a particular website, which is supported by the server computer 100.

A detailed description of FIG. 2 will be made hereinafter. The user computers 3, 4 and 5 are provided with typical display devices and input devices to be used for connecting users to a web server 70. Server computer 1 includes a main controller 10, a network module 20, a network interface 30, a member DB 60, a web server 70, a user community server 80, and a user DB 90.

The main controller 10 controls the interface with the network module 10.

The network module 20 processes packets transmitted over the network.

The network interface 30 conducts converting analogue signals of the network and digital signals in the system.

The web server 70 transmits to a user a web page created in HTML, for example. It receives a web page from an external server (not shown), when requested, and stores it in temporary memory. It extracts IP addresses from TCP/IP (Transmission Control Protocol/Internet Protocol) packets. Alternatively, the web server 70 may extract IP addresses from the user community server 80.

The user community server 80 determines user IDs so that it can carry out a temporary community per web page on the basis of user IP addresses. The community server 80 stores, in the user DB 90, the user IDs that are determined according to a predefined ID determining rule corresponding to IP addresses of the users. A non-member user is given a temporary ID determined according to the predefined ID determining rule. When there is a request for access to the web page from a user, the user community server 80 searches the user's IP address in the user DB 90. If the user is a new visitor to the web page, i.e., no information about the user's IP address is found in the user DB 90, the user community server 80 registers a newly determined ID for the user, the corresponding IP address, the requested web page, and time of the last access to the web page in the user DB 90. The user ID may be “user 1”, “user 2” and so on, in the order of registration. This determining method using anonymity allows assigning user IDs temporarily.

In one embodiment of the present invention, the user may also be a registered member of the web site providing the user community service. If the user logs in on the web site as a registered member, then he/she can use his/her member ID as the user ID.

Meanwhile, if user information is already stored at the user DB 90, the user community server 80 updates information about the web page and time of the last access.

The user DB 90 stores user information such as user's IP address, ID, a web page that the user is now viewing, and the time of the last access. The user DB 90 deletes user information of a user from the user DB 90 if the user has not accessed the web page for a predetermined time.

The member DB 60 stores member information about members registered with the web site.

According to the present invention, in order to provide users with a list of current users visiting a web page, the user community server 80 extracts only the IDs of the current users and creates a list of the extracted IDs for transmitting to the web server 70.

The web server 70 transmits web pages requested by users and a list of user IDs of other users to the user computers.

The IDs of new visitors to a web page are not automatically updated for a user unless he/she accesses the web page again.

As mentioned above, user information of a user is deleted from the user DB 90 when there is no activity on the part of the user. However, this also can happen when the user reads the web page for the predetermined time. In order to prevent this situation, the connection to the web server can be automatically refreshed periodically so that the user information is not deleted the user database.

As stated above, viewing a web page including an updated user list, the user may invite one or more on the list to a chat room or send a message to them. The invitation or message is sent to the server computer 100 and stored as user information for a target user at the user DB 90. The target user may check the invitation or the message in a new window provided when he/she refreshes the web page.

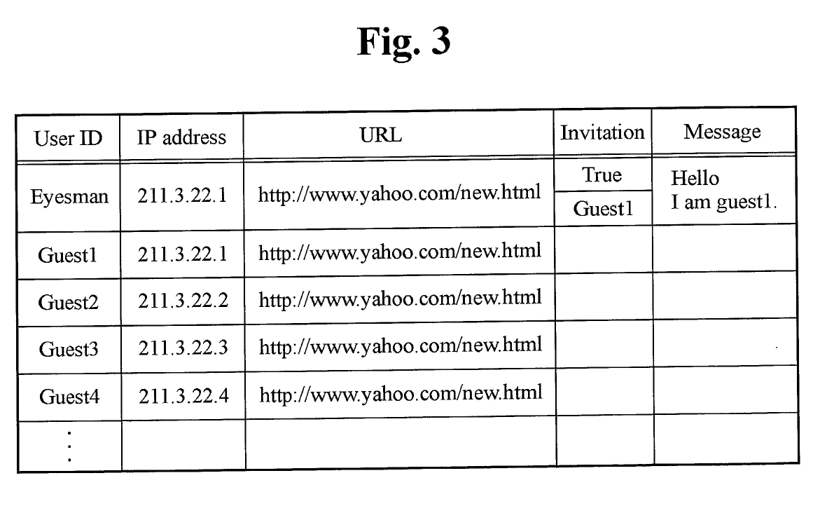

FIG. 3 denotes a data format stored at the user DB of the present invention. The data includes ID, IP address, URL (Uniform Resource Locator) of currently viewing web page, invitation status, and messages of a user accessing the server computer 100.

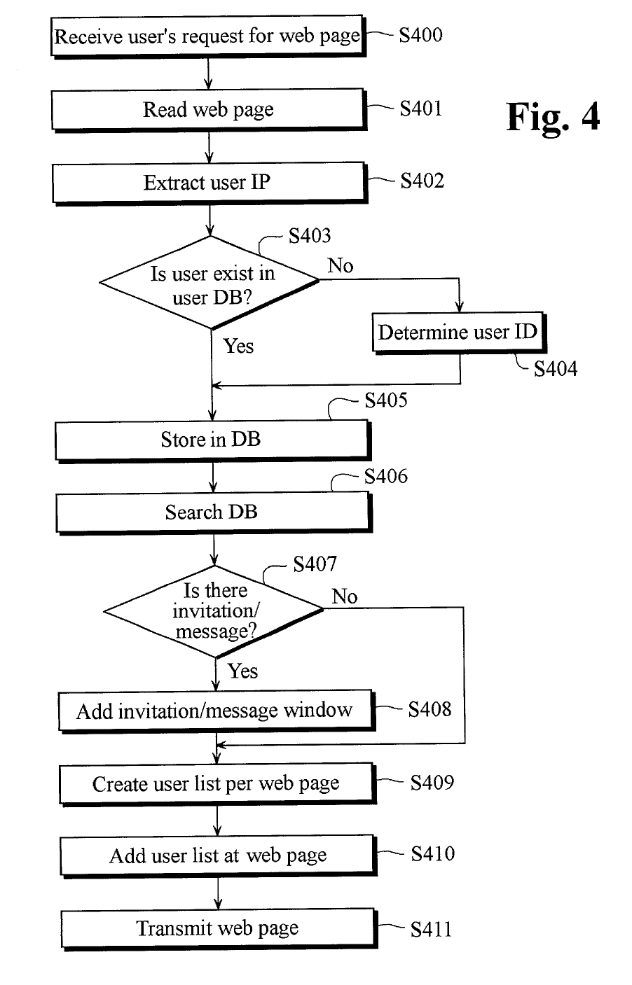

FIG. 4 shows a flow of a process for providing the user community service according to the present invention.

At the step S400, the web server 70 receives a request for access to a web site from a user computer.

At the step S401, the web server 70 retrieves a requested web page and stores it in temporary memory.

At the step S402, the web server 70 extracts the IP address of the user form the TCP/IP packets and transmits it to the user community server 80.

At the step S403, the user community server 80 checks whether the IP address was registered or not. If the IP address was registered, the step S405 is performed. Otherwise, the step S404 is taken.

At the step S404, the user community server 80 determines an ID for the user, and registers it together with the IP address in the user DB 90.

At the step S405, the user community server 80 stores user information such as the URL of the requested web page and the last access time in the user DB 90.

At the step S406, the user community server 80 searches the user DB 90 for the user information of the user and the user IDs of users who have been accessing the requested web page for a predetermined time.

At the step S407, the user community server 80 confirms whether there is any transmitted invitation or a massage to the user or not, and if there is found at least one of the two, the step S408 is performed. Otherwise, the step S409 is taken.

At the step S408, the user community server 80 delivers the transmitted invitation or message to the web server 70, and the web server 70 adds a new window for the invitation and/or the message.

At the step S409, the user community server 80 creates a user list including the IDs of the users accessing the particular web page for a predetermined time, and transmits it to the web server 70.

At the step S410, the web server 70 adds the user list at a predefined position on the web page. At the step 411, the web server 70 transmits the updated web page to the user computer.

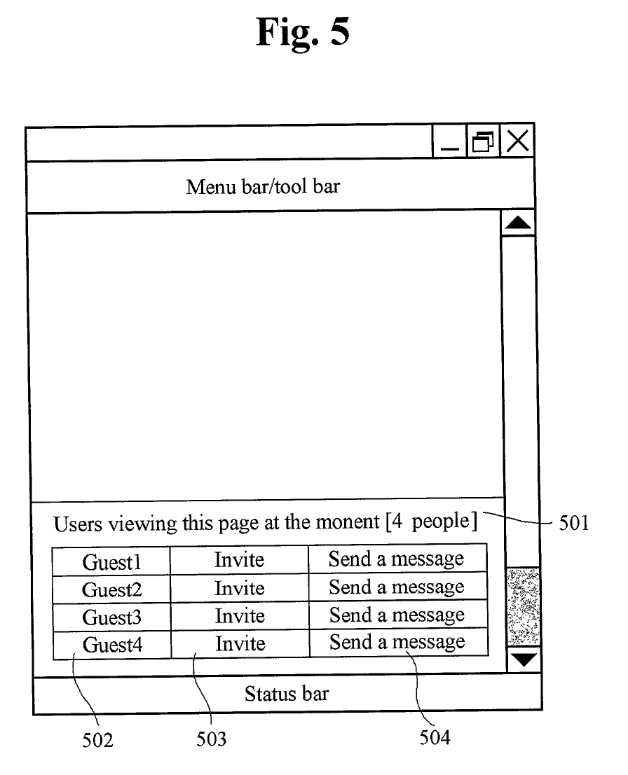

FIG. 5 depicts an exemplary screen displaying a current user list.

At the end of the web page, for example, the number of current users and the user list may be displayed along with invitation and/or message options next to user names.

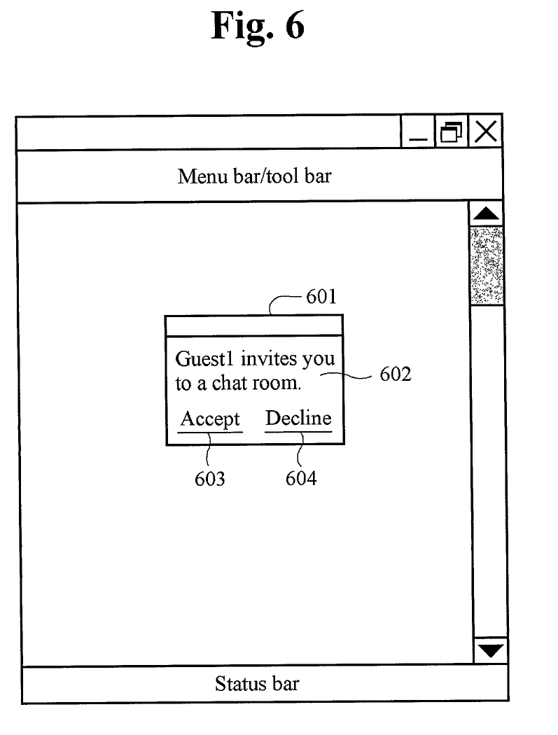

FIG. 6 depicts an exemplary screen displaying the receipt of an invitation.

A new window 601 pops up displaying a notice 602 notifying that other user invited the user to a chat room. The user may click an Accept icon 603 for accepting the invitation or a Decline icon 604 for declining the same. A detailed description about the chat room is omitted since it is a well-known technique in the art.

While the preferred embodiment of the present invention has been described using specific terms, such description is for illustrative purposes only, and it is to be understood that changes and variations may be made without departing from the spirit or scope of the appended claims.

What is claimed is:

1. A server computer, interconnected with a plurality of user computers via the Internet, comprising:
a database for storing user information of the plurality of users respectively;
a storing means for temporarily storing a web page requested by the plurality of users respectively;
a first processing means for updating the database upon receipt of the web page from the plurality of users, and extracting a list of current users of the requested web page from the user information stored in the database; and
a second processing means for receiving the extracted user list, and providing it to the corresponding users by adding at a predefined position on a corresponding web page respectively, the web page stored temporarily.

2. The server computer of claim 1, further comprising a third processing means for determining user IDs (Identifications) corresponding to IP addresses of the plurality of users respectively, wherein the user information includes IP addresses and IDs of the users and URL (Uniform Resource Locator) of the requested web page.

3. The server computer of claim 2, wherein the user list is a list showing the users IDs.

4. The server computer of claim 3, wherein, when the first processing means receives an invitation for inviting a target user selected from the user ID list to a chat room, the first processing means stores the target user's ID at the database and displays an inviting user's ID to the target user when the target user requests for the web page.

5. The server computer of claim 3, wherein, when the first processing means receives a message designating a recipient selected from the user ID list, the first processing means stores the message in the database and displays the message to the designated recipient when the recipient requests for the web page.

6. A method for providing a list of current users of a particular web page in a server computer, the server computer interconnected with a plurality of user computers via the Internet, comprising the steps of:
a) temporarily storing a web page requested by the plurality of users upon receipt of requests from the users;
b) storing user information of the plurality of the respective users;
c) extracting the list of current users of the requested web page from the information stored at the step (b); and
d) providing the list to corresponding users by adding at a predefined position on the corresponding web page respectively, the web page stored temporarily.

7. The method of claim 6, further comprising the step of e) determining user IDs corresponding to IP addresses of the plurality of users respectively, wherein the user information includes IP addresses and IDs of the users and URL of the requested web page.

8. The method of claim 7, wherein the user list is a list showing the user IDs.

9. The method of claim 8, further comprising the steps of:
f) storing a target user's ID in the database, when there is an invitation for inviting the target user selected from the user ID list to a chat room; and
g) displaying an inviting user's ID to the target user when the target user requests for the web page.

10. The method of claim 8, further comprising the steps of:
h) storing a message in the database, when there is a message designating a recipient selected from the user ID list; and
i) displaying the message to the designated recipient when the recipient requests for the web page.
